(19) United States
(12) Patent Application Publication
(10) Pub. No.: US 2005/0145541 A1
(43) Pub. Date: Jul. 7, 2005

(54) Hydrocracking catalyst and process of producing liquid hydrocarbon

(75) Inventors: Hisao Sakoda, Yokohama-shi (JP); Hirofumi Konno, Yokohama-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Nippon Oil Corporation

(21) Appl. No.: 11/074,567

(22) Filed: Mar. 8, 2005

Related U.S. Application Data
(63) Continuation of application No. PCT/JP03/11849, filed on Sep. 17, 2003.

(30) Foreign Application Priority Data
Apr. 8, 2004 (JP) WO 2004/028688 A
Sep. 24, 2002 (JP) 2002-277424

(51) Int. Cl. C10G 47/00; B01J 29/06

(52) U.S. Cl. 208/111.3; 208/111.01; 208/111.35; 502/64

(57) ABSTRACT

A catalyst is provided for hydrocracking paraffinic hydrocarbons which simultaneously the three requirements of high cracking activity and high selectivity of middle distillates as well as the low pour point of the resulting gas oil; and a process is provided for producing liquid hydrocarbons using the catalyst. The catalyst is characterized in that it comprises (a) a crystalline aluminosilicate and (b) an amorphous aluminosilicate at a weight ratio of 0.01<(a)/(b)<1.0. Furthermore, the catalyst is characterized in that it further comprises a group VIb metal and/or a group VIII metal.

### TECHNICAL FIELD

The present invention relates to a catalyst for producing liquid hydrocarbons from paraffinic hydrocarbons in the presence of hydrogen and a process of producing liquid hydrocarbons using such a catalyst.

### BACKGROUND ART

In recent years, demands have been escalating rapidly toward a clean liquid fuel which is low in contents of sulfur and aromatic hydrocarbons. In response to such demands, the fuel oil manufacturers have already been studying various clean fuel production processes. Among these, a process has been considered to be the most prospective in which process paraffinic hydrocarbons such as waxes are hydrocracked in the presence of a catalyst.

In a process of hydrocracking of a paraffinic hydrocarbon, it is important to obtain useful middle distillates with high yields at low temperatures. In addition, the resulting gas oil is necessarily low in pour point. In other words, the development of a highly efficient hydrocracking catalyst which is high in cracking activity and selectivity of middle distillates and can provide the resulting gas oil with low pour point holds the key to the improvement of the process in economical view.

The hydrocracking of a vacuum gas oil is a technology which has been established for more than decades. However, since the difference between the reactivity of a paraffinic hydrocarbon and that of a vacuum gas oil is so significant that it is difficult to use the catalyst for the latter as it is for the hydrocracking of a paraffinic hydrocarbon, the research and development have been continued vigorously to aim the development of a highly efficient catalyst for paraffinic hydrocarbons. Patent applications for such a catalyst, although they are few, have been filed. For example, Japanese Patent Laid-Open Publication No. 6-41549 discloses a catalyst comprising platinum supported on a carrier containing an amorphous aluminosilicate.

However, the amorphous aluminosilicate-containing catalyst is at a satisfactorily higher level of the middle distillate selectivity and the capability to provide the resulting gas oil with low pour point but at a disadvantage in that the cracking activity is low. Contrary to this, the use of a crystalline aluminosilicate such as zeolite instead of an amorphous aluminosilicate can achieve high cracking activity but fails to obtain sufficient middle distillate selectivity and to provide the resulting gas oil with low pour point. That is, there has not been developed a catalyst which satisfies high cracking activity and middle distillate selectivity as well as the low pour point of the resulting gas oil at the same time, leading to a serious hindrance to an economical improvement of the hydrocracking process of paraffinic hydrocarbons.

The object of the present invention is to provide a novel catalyst for hydrocracking a paraffinic hydrocarbon which is satisfactorily high in cracking activity and middle distillate selectivity and successfully provides the resulting gas oil with low pour point so as to improve the productivity of the hydrocracking process.

### DISCLOSURE OF THE INVENTION

As a result of an extensive research made by the present inventors, they completed the present invention upon finding that the above-described problems can be solved with a catalyst comprising a crystalline aluminosilicate and an amorphous aluminosilicate at a specific ratio.

That is, the present invention relates to a catalyst for hydrocracking paraffinic hydrocarbon which comprises (a) a crystalline aluminosilicate and (b) an amorphous aluminosilicate at a weight ratio of 0.01≦(a)/(b)≦1.0.

The present invention also relates to such a catalyst which further comprises a group VIb metal and/or a group VIII metal.

Furthermore, the present invention relates to a process for producing a liquid hydrocarbon wherein a paraffinic hydrocarbon is hydrocracked using the catalyst.

The present invention will be described in more detail below.

The term “aluminosilicate” used herein denotes a metal oxide constituted by three elements, i.e., aluminum, silicon, and oxygen. Although another metal element may coexist to an extent that the effects achieved by the present invention are not bothered, the amount of such a metal element is 5 percent by mass or less, preferably 3 percent by mass or less of the total amount of alumina and silica in the oxide. Examples of the metal element which may coexist are titanium, lanthanum, and manganese.

The crystallinity of aluminosilicate can be estimated with the proportion of tetrahedrally coordinated Al atoms in all the Al atoms which can be measured by a solid ²⁷Al NMR spectrum. Crystalline aluminosilicates used in the present invention are those whose proportion of tetrahedrally coordinated Al atoms is 50 percent or more. Any crystalline aluminosilicate as long as the proportion of tetrahedrally coordinated Al atoms is 50 percent or more can be used in the present invention. Although not restricted, there is usually used those containing 70 percent or more, preferably 80 percent or more of the tetrahedrally coordinated Al atoms. The amorphous aluminosilicates to be used in the present invention are those wherein the proportion of tetrahedrally coordinated Al atoms is 3 percent or less.

Crystalline aluminosilicates eligible for the present invention are so-called zeolites. Preferred are Y- or USY-type zeolite, beta-type zeolite, mordenite, and ZSM-5, and most preferred is USY-type zeolite. If necessary, two or more types of crystalline aluminosilicates may be used.

No particular limitation is imposed on the alumina content in the crystalline aluminosilicate to be used in the present invention. However, the content is preferably from 1 to 10 percent by mass and more preferably from 2 to 8 percent by mass.

No particular limitation is imposed on the particle size of the crystalline aluminosilicate to be used in the present invention. However, the particle size is preferably 3 μm or smaller, more preferably 1 μm or smaller, and particularly preferably 0.5 μm or smaller.

Amorphous aluminosilicates eligible for the present invention are so-called silica-aluminas.

No particular limitation is imposed on the alumina content in the amorphous aluminosilicate to be used in the present invention. However, the content is preferably from 4 to 30 percent by mass, more preferably from 8 to 20 percent by mass, and most preferably from 10 to 15 percent by mass.

No particular limitation is imposed on the particle size of the amorphous aluminosilicate. However, the particle size is 10 μm or smaller with the objective of the strength of the resulting catalyst.

No particular limitation is imposed on the pore volume of the amorphous aluminosilicate to be used in the present invention. However, the pore volume is preferably from 0.5 to 0.9 ml/g and more preferably from 0.6 to 0.8 ml/g.

The term “paraffinic hydrocarbon” used herein denotes hydrocarbons the paraffin content of which is 70 percent or more. No particular limitation is imposed on the carbon atom number of the hydrocarbon molecules. However, those having from 10 to 100 carbon atoms are usually used. The catalyst of the present invention is particularly effective for hydrocracking paraffinic hydrocarbons having 20 or more carbon atoms, so-called “wax”.

No particular limitation is imposed on the process of producing a paraffinic hydrocarbon which will be the feedstock of the hydrocracking process. Therefore, the catalyst of the present invention is applicable to various paraffinic hydrocarbons which may be petroleum-based or synthetic ones. However, particularly preferred paraffinic hydrocarbons are FT waxes produced by Fischer-Tropsch synthesis.

The catalyst for hydrocracking paraffinic hydrocarbons according to the present invention is characterized in that it comprises (a) a crystalline aluminosilicate and (b) an amorphous aluminosilicate at a weight ratio of 0.01≦(a)/(b)≦1.0.

Preferred weight ratio is 0.02≦(a)/(b)≦0.5 while particularly preferred weight ratio is 0.04≦(a)/(b)≦0.2. If (a)/(b) is less than 0.01, the cracking activity of the resulting catalyst would be poor. If (a)/(b) is greater than 1.0, the middle distillate selectivity would be decreased.

High cracking activity and high middle distillate selectivity as well as the low pour point of the resulting gas oil can be satisfactorily achieved at the same time only when a catalyst comprises (a) a crystalline aluminosilicate and (b) an amorphous aluminosilicate at an extremely restricted weight ratio, i.e., of 0.01≦(a)/(b)≦1.0. This is a novel finding which can not be observed through hydrocracking of vacuum gas oils and is peculiar to the hydrocracking of paraffinic hydrocarbons and such a finding could not be expected at all.

The catalyst of the present invention can be prepared by molding a crystalline aluminosilicate and an amorphous aluminosilicate used at the above-described weight ratio into a desired shape using a binder such as alumina by a well-known process. Alternatively, if necessary, a process may be employed in which only a crystalline aluminosilicate is molded with a binder that turns into an amorphous aluminosilicate.

The catalyst of the present invention further comprises a group VIb metal and/or a group VIII metal as active components. Specific examples of the group VIb metal include chromium, molybdenum, and tungsten. Specific examples of the group VIII metal include cobalt, nickel, rhodium, palladium, iridium, and platinum. The catalyst of the present invention can be produced by loading these metals on the above-described mold by a well-known process such as impregnation or ion-exchange.

The type and amount of the metal to be loaded are arbitrary selected as needed. For example, a noble metal such as platinum and palladium may be loaded. No particular limitation is imposed on the amount of the noble metal to be loaded. However, the amount is usually from 0.05 to 2 percent by mass. A base metal such as nickel, cobalt, tungsten, and molybdenum may be arbitrary used in combination as needed.

The catalyst of the present invention may be used in a conventional fixed bed reactor apparatus. Typical reaction conditions are a reaction temperature of 250 to 400° C., a hydrogen pressure of 0.5 to 10 MPa, and an LHSV (liquid hourly space velocity) of paraffinic hydrocarbon feedstock of 0.5 to 10/h.

[Industrial Applicability]

As described above, the use of a catalyst comprising (a) a crystalline aluminosilicate and (b) an amorphous aluminosilicate at a weight ratio of 0.01≦(a)/(b)≦1.0 can achieve satisfactorily high cracking activity and high middle distillate selectivity as well as the low pour point of the resulting gas oil at the same time in a paraffinic hydrocarbon hydrocracking process.

### BEST MODE FOR CARRYING OUT THE INVENTION

The present invention will be described in more detail with reference to the following examples and comparative example but are not limited thereto.

### EXAMPLE 1

Crystalline aluminosilicate (a) and amorphous aluminosilicate (b) indicated in Table 1 below were used at an (a)/(b) weight ratio of 0.08 and boehmite in an amount of 30 percent by mass of the total amount of (a) and (b) was added thereto as a binder. The mixture was kneaded and molded into a column-like shape with a diameter of 1/16 inch (about 1.6 mm), followed by calcination thereby obtaining a catalyst support.

The support was dipped into a water soluble solution of dichlorotetraammine platinum (II) such that the solution was impregnated in an amount of 1.0 percent by mass of the support, followed by drying and calcination thereby preparing Catalyst A-1.

Catalyst A-1 was filled into a fixed bed flow reactor and used to hydrocrack a paraffinic hydrocarbon. The feedstock used herein was an FT wax whose paraffin content was 91 % and carbon number distribution was from 30 to 80. The hydrogen pressure was 5 MPa, while the LHSV of the feedstock was 2.0/h. The fraction whose boiling point was 360° C. or lower was defined as “cracked product”, the lowest reaction temperature at which the conversion rate of the feed stock to the cracked product reached 60 mass % was defined as “cracking temperature”, and the proportion of the middle distillate whose boiling point was from 145 to 360° C. in the cracked product obtained at the cracking temperature was defined as “middle distillate selectivity”. With Catalyst A-1, the cracking temperature and middle distillate selectivity were 295° C. and 81 %, respectively. The gas oil fraction whose boiling point was from 260 to 360° C. in the cracked product had a pour point of −37.5° C.

TABLE 1

| | Crystalline | Amorphous |
|---|---|---|
| | Aluminosilicate | aluminosilicate |
| Name | (a) | (b) |
| Type | USY-type zeolite | silica-alumina |
| Tetrahedrally coordinated Al % | 82 | 0 |
| Particle diameter μ m | 0.72 | 6 |
| Alumina content mass % | 7.8 | 12.0 |
| N. B. | | Pore vol.: 0.65 ml/g |

### EXAMPLES 2 TO 5

Catalysts A-2, A-3, A-4 and A-5 were prepared by following the procedures for the preparation of Catalyst A-1 except that their (a)/(b) weight ratios were 0.015, 0.181, 0.375, and 0.814, respectively. The hydrocracking of a paraffinic hydrocarbon was conducted using each of Catalysts A-2, A-3, A-4 and A-5 in the same manner for Catalyst A-1. The results are shown in Table 2.

### COMPARATIVE EXAMPLES 1 TO 3

Catalysts B-1, B-2 and B-3 were prepared by following the procedures for the preparation of Catalyst A-1 except that their (a)/(b) weight ratios were 0.005, 1.155, and 2.510, respectively. The hydrocracking of a paraffinic hydrocarbon was conducted using each of Catalysts B-1, B-2 and B-3 in the same manner for Catalyst A-1. The results are shown in Table 2.

(Control Experiments Using Vacuum Gas Oil as the Feedstock)

The efficiency of each of Catalysts A-1, A-2, A-3, A-4, A-5, B-1, B-2, and B-3 was evaluated in the same manner as described above using a vacuum gas oil (paraffin content: 7.6%) which can be obtained through the refining process of crude oil, instead of the FT wax with 91% paraffin content. The results are shown in Table 2.

TABLE 2

| | | | Feedstock: Paraffinic Hydrocarbon | | | Feedstock: Vacuum Gas Oil (Control) | | |
|---|---|---|---|---|---|---|---|---|
| | | | | Middle | | | Middle | |
| | | Alumino- | Cracking | Distillate | Pour Point | Cracking | Distillate | Pour Point |
| | | silicate | Temperature | Selectivity | of Gas Oil | Temperature | Selectivity | of Gas Oil |
| | Catalyst | (a)/(b) | ° C. | ° C. | ° C. | ° C. | ° C. | ° C. |
| Example 1 | A-1 | 0.08 | 295 | 81 | −37.5 | 362 | 73 | −27.5 |
| Example 2 | A-2 | 0.015 | 298 | 81 | −37.5 | 365 | 75 | −27.5 |
| Example 3 | A-3 | 0.181 | 290 | 80 | −37.5 | 360 | 73 | −27.5 |
| Example 4 | A-4 | 0.375 | 290 | 79 | −35.0 | 359 | 74 | −27.5 |
| Example 5 | A-5 | 0.814 | 290 | 77 | −35.0 | 359 | 73 | −27.5 |
| Comparative | B-1 | 0.005 | 331 | 81 | −37.5 | 365 | 75 | −27.5 |
| Example 1 | | | | | | | | |
| Comparative | B-2 | 1.155 | 290 | 69 | −17.5 | 358 | 73 | −27.5 |
| Example 2 | | | | | | | | |
| Comparative | B-3 | 2.510 | 285 | 55 | −7.5 | 355 | 71 | −27.5 |
| Example 3 | | | | | | | | |

As apparent from Table 2, only the catalysts with the specific (a)/(b) weight ratio according to the present invention can satisfy high cracking activity and high middle distillate selectivity as well as the low pour point of the resulting gas oil simultaneously when the catalysts are used for the hydrocracking of paraffinic hydrocarbon. It is also apparent from the control experiments that when the feedstock was a vacuum gas oil, the catalysts with the specific (a)/(b) according to the present invention could not achieve the same excellent results.

1. A catalyst for hydrocracking a paraffinic hydrocarbon which comprises (a) a crystalline aluminosilicate and (b) an amorphous aluminosilicate at a weight ratio of 0.01≦(a)/(b)≦1.0.

2. The catalyst according to claim 1 which further comprises a group VIb metal and/or a group VIII metal.

3. A process for producing a liquid hydrocarbon wherein a paraffinic hydrocarbon is hydrocracked using the catalyst as defined in claim 1.

4. A process for producing a liquid hydrocarbon wherein a paraffinic hydrocarbon is hydrocracked using the catalyst as defined in claim 2.
